(19) United States
(12) Patent Application Publication
(10) Pub. No.: US 2006/0080207 A1
(43) Pub. Date: Apr. 13, 2006

(54) METHOD, SYSTEM AND INTERNET PLATFORM FOR CLASSIFIED REQUEST AUCTION

(76) Inventors: BINUMON T GIRIJA, SUNNYVALE, CA (US); DIVYA VIJAYALAKSHMI, SUNNYVALE, CA (US)

Correspondence Address: BINUMON T. GIRIJA, 777 SOUTH MATHILDA AVE #132, SUNNYVALE, CA, 94087, US

(21) Appl. No.: 10/711,924

(22) Filed: Oct. 13, 2004

(51) Int. Cl. G06Q 40/00

(52) U.S. Cl. 705/37

(57) ABSTRACT

An auction method, system and Internet platform where registered requesters/buyers (here in after used as Buyer or Requester) post their requests/classifieds and registered providers/sellers (here in after used as Provider or Seller) provide bids/competitive rates. More particularly, the invention provides a central platform for all kinds of residential and business related services or products. This platform includes several web servers, which receive requests/classifieds from registered requesters/buyers to get bids/competitive rates from registered providers/sellers through web clients. Requester/Buyer has an option to accept a sealed or unsealed bid. This information, (i.e. Classifieds, service or product requests, bids) which is related to this process will be collected and stored in the database server. Requester/Buyer will select the provider/seller based on the bid details and the profile of the provider/seller. Requester/Buyer has an option to cancel the auction or end the auction by selecting a provider/seller at anytime. Buyer/Requester is also given a feature to buy any service or package of service instantly from the seller or negotiate with the provider/seller even the listed price is fixed.

### CROSS REFERENCE TO RELATED APPLICATIONS

### U.S. Patent Documents

| | | | |
|---|---|---|---|
| 5664115 | September, 1997 | Fraser | 705/37. |
| 5689652 | November, 1997 | Lupien et al. | 705/37. |
| 5727165 | March, 1998 | Ordish et al. | 705/37. |
| 5794207 | August, 1998 | Walker et al. | 705/23. |
| 5905975 | May, 1999 | Ausubel | 705/37. |
| 6202051 | March, 2001 | Woolston | 705/27. |
| 6266651 | July, 2001 | Woolston | 705/27. |
| 6401080 | June, 2002 | Bigus et al. | 705/37. |
| 6415269 | July, 2002 | Dinwoodie | 705/37. |

### BACKGROUND OF INVENTION

As Internet Platform becomes more popular, transactions are carried out over the Internet. Online Auction websites are one of the methods in Internet platforms.

1. Field of Invention

This application relates generally to methods, systems and Internet platforms for conducting online auctions in which providers/sellers perform the bidding and requesters/buyers posts requests.

2. Background Art

As Internet and e-commerce technology grows aggressively and the Internet becomes more popular, transactions are being carried out over the Internet. As one form of this, there are online reverse auction sites. A reverse online auction is a method in which sellers perform the bidding based on the buyer's postings. Generally, buyer sets an opening price for the auction and the sellers' bid price decreases in pre-determined amount. Also, the winning seller is selected based on the lowest bid price. Many Internet sites use different classes of reverse auction.

The significant deficiencies of all these online auction methods are:
1. They fail to support day-to-day service needs of individuals and businesses.
2. They fail to integrate all these methods under one platform.
3. Because of the pre-defined opening price, provider/seller may not be able to give an accurate bid and no options are available for defining or describing the boundary of work the provider/seller can perform.
4. When the winning provider/seller is selected based on the lowest bid, the buyer is forced to accept seller's services without any prior or referenced knowledge (i.e. profile, feedback, ratings) about the seller.
5. There is no method, which gives the buyer an option to accept a sealed or unsealed bid. In many of the sites the bidding will be either sealed or unsealed, which is fixed. The buyers or sellers never get any control over that.
6. There is no method in which the buyer can negotiate/bargain with the seller in an instant buy process.
7. The current models work well for products, but are not suited for services where payment is typically made after the service has been provided.

The present invention overcomes this defectiveness, as described in detail below.

### SUMMARY OF INVENTION

The present invention comprises of a system and method that provides classified auction of products and services, which covers day-to-day service/products needs of individuals and business under one platform.
The present invention also provides a system that does not force the requester to specify an opening price. The present invention also provides a feature for provider, which allows entering a detailed description which can define or describe the boundary of service along with the bid amount. This feature can avoid the conflicts between the provider/seller and a requester/buyer in later stage.
The present invention further provides the requester/buyer a feature to select the winning provider/seller based on the bid amount, bid description, profile, feedback and ratings. This feature gives the requester/buyer more flexibility to choose a right provider/seller, who can satisfy the complete needs.
The present invention also provides a feature called quickbuy that allows the requester/buyer to find ready to buy service or a package of services, which are posted by the provider/seller. This feature helps the requesters/buyers who do not have enough time to post request or classified into the auction system and wait till they get competitive bids from providers/sellers.
The present invention provides a method that allows the requester/buyer and provider/seller to negotiate on Quick Buy offer, which is posted, by the provider/seller.
The present invention also provides a feature to accept sealed or unsealed bid. A sealed bid hides the bid amount from the public. If the requester/buyer agrees to accept sealed bids the provider/seller can place either a sealed or unsealed bid. This feature helps the provider/seller to hide the bid amount from the public and the requester/buyer is getting complete control.
The present invention allows for the payment to be taken from the provider/seller instantly as the bid is won. The payment is taken based on the matching of the requester/buyer to the provider/seller.
The present invention allows for notifications to be sent by multiple media (Wireless, Bluetooth, SMS, email etc.)

### BRIEF DESCRIPTION OF THE DRAWINGS

The supplied drawings, which are incorporated herein and constitute a part of this specification, illustrate the presently preferred embodiments of the invention and together with the general description given above and the detailed description given below, serve to explain the features of invention.

FIG. 1 is a block diagram showing the structure of the auction system relating to the present invention (Prior Art)

FIG. 2 is a flow diagram showing the process of buyer/requester registration. (Prior Art)

FIG. 3 is a flow diagram showing the process of seller/provider account creation. (Prior Art)

FIG. 4A and FIG. 4B are block diagrams showing the process flow in buyer/requester's point of view.

FIG. 5A and FIG. 5B are block diagrams showing the process flow in seller/provider's point of view.

FIG. 6A and FIG. 6B are flow diagrams describing the feature called quickbuy and negotiations between buyer/requester and seller/provider.

### DESCRIPTION OF THE PRIOR ART

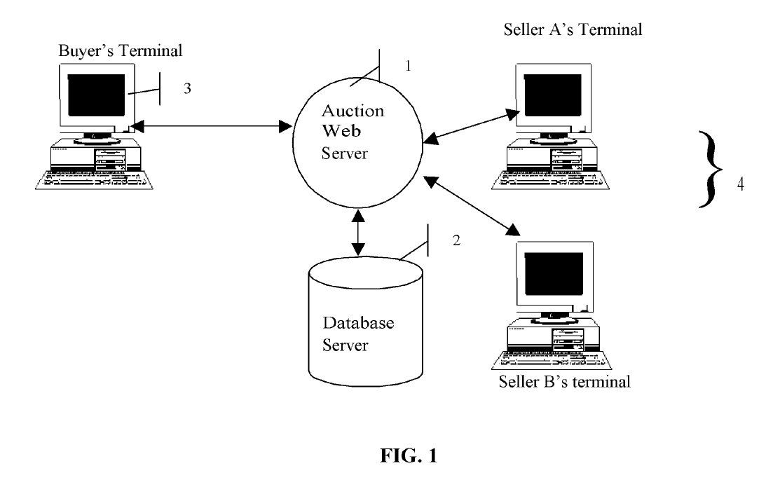

FIG. 1 shows in a simple block diagram a real-time, interactive auction system in accordance with the principles of present invention. The system mainly includes an auction web server 1, a database server 2, buyer's terminal 3, and seller's terminals 4. Buyer's terminal 3 and sellers' terminals 4 are connected to auction web server 1 through the Internet.

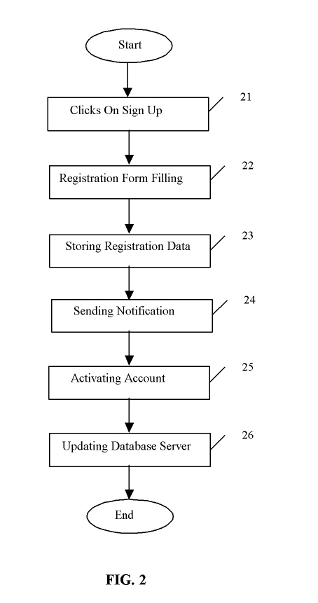

FIG. 2 shows in a simple block diagram the process of buyer registration, which is mandatory for all first-time visitors.—After clicking on the Sign Up (Step 21) link or button. The user will—be taken to a web page that contains a Registration form (Step 22). The form will collect Information—including Name, address, Phone number, e-mail address—and a unique user id and password.—. This information will be stored (Step 23) in the user information tables of the Database server 2. The web server 1 will send a confirmation e-mail (Step 24) to the user. The user activates the account (Step 25) after which the database server 2 updates (Step 26) the buyer account information and the buyer account will be activated.

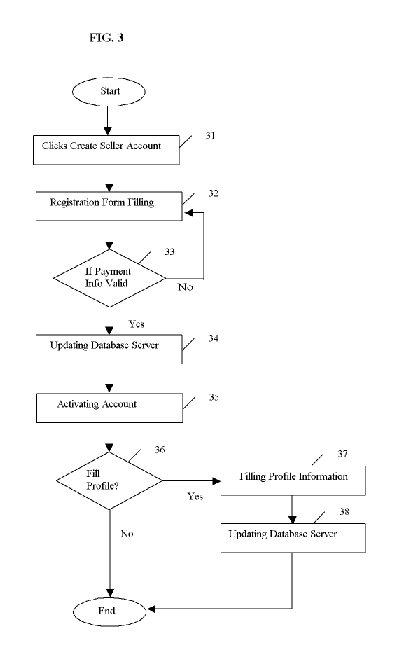

FIG. 3 shows a block diagram depicting the process of seller account creation. A registered user desiring to place bids must upgrade to a seller account. The user clicks on a button or link (Step 31) and is taken to a web page containing a form used (Step 32) to confirm previously entered information. This information is sent to web server 1 through a secured socket Layer. A validation process (Step 33) will send this information to the corresponding Payment Gateway for validation. If the card information is invalid the user will be asked to enter correct Credit/Debit card information (Step 32) and the above validation process (Step 33) repeats. If the validation process passes through correctly, all collected information will be stored (Step 34) in the corresponding tables of Database Server 2.This is followed by activation (Step 35) of seller's account. Once this process is completed the seller will be given an option to (Step 36) create a profile, which may contain brief description of the services or products offered. The profile information entered (Step 37) by the seller is sent to Web server 1 and stored (Step 38) in the Database server 2, completing the seller account activation process.

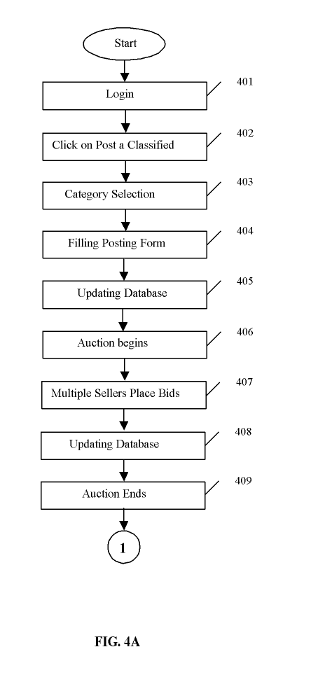

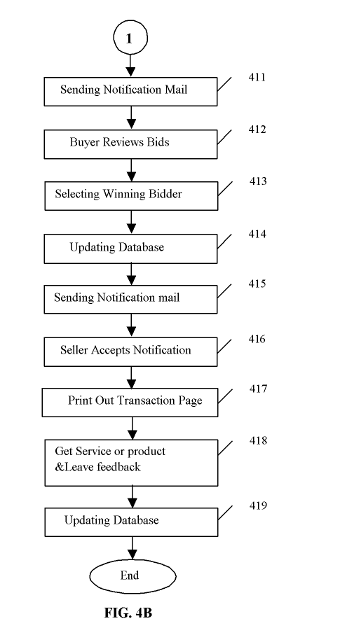

FIG. 4A and FIG. 4B, show a block diagram of the process flow from the buyer's point of view. A registered buyer should login (Step 401) by validating the userid. The buyer clicks on the “Post a request/classified” button or link (Step 402) for putting a classified in the auction system and is taken to a Classified/request posting process. The first step in this process is category selection (Step 403). The user is then taken to a page containing a form (Step 404) for collecting the details of the service or product. This may also include a title of the posting, zip code, description, any further information that is required to describe the service or product, starting date of auction and the period of auction listing. Auction starting time can be scheduled according to buyer's choice.

Once the posting form is submitted to the web server 1, web server 1 will assign an auction id and all the information belonging to this request will be stored (Step 405) in the database server 2. The web server 1 automatically starts the auction listing at the time specified by the buyer. Once the auction starts (Step 406) Sellers will be able to bid (Step 407) for the buyer's request/classifieds and the bidding information will be sent to the web server and stored (Step 408) in the corresponding database tables in the database server 2. When the auction ends (Step 409) after the specified listing period, the buyer will be notified (Step 411) for example through email. The buyer can review the bids (Step 41 2), which he received and select the winner (Step 413) based on the bid details, seller's profile, and feedback received through prior auctions. The winning bidder's details will be stored (Step 414) in the database server 2.

The web server 1 will send a notification email (Step 415) to the winning seller and the seller then confirms the acceptance (Step 416).

The seller and buyer will be advised to take a printout (Step 417) of the finished transaction. This can contain information related to the service or product and contact details of seller and buyer.

Once the seller and buyer complete the transaction of the specified service or product, both of them can leave mutual feedback (Step 418). This will be stored (Step 419) in the database server 2 for future reference.

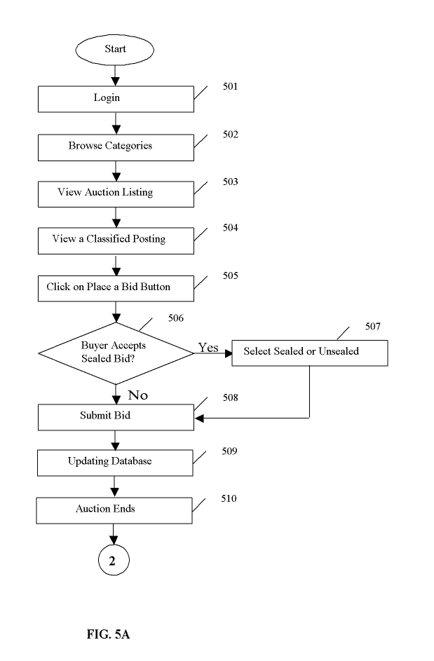

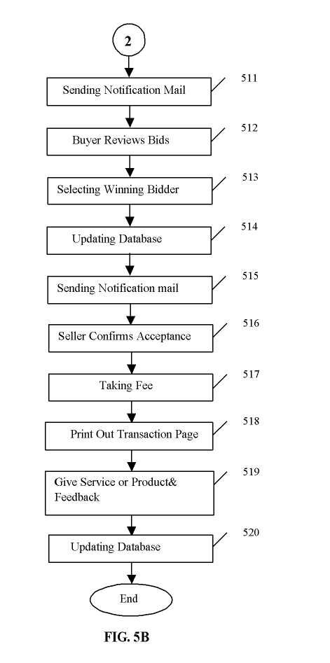

Referring to FIG. 5A and FIG. 5B, there is shown a block diagram showing the process flow in Sellers point of view. A registered seller should login (Step 501) to the auction website by validating the userid, and password in order to place a bid.

Once the seller has logged in he can browse through the product or service categories (Step 502) and find categories in which he can provide any product or service. When the seller clicks on a particular category, he will be taken to a web page in which all postings belonging to that specific category are listed (Step 503). That listing may contain the title of the classified or request, number of bids obtained, Time left for the end of auction and current bid price.

If a seller wants to view the details of a particular posting, he needs to click on the title of that posting or a button associated with that posting. The seller will then be taken to a page (Step 504), which will contain all the information entered by the buyer. This may include title of the posting, zip code of buyer, detailed description, any further information that is required to describe the service or product, starting date of auction and time left for end of auction. Also a provision to contact the buyer for more information will be included in this page.

If the seller wishes to place a bid for this classified or request he should click on the Bid button (Step 505). The seller will then be taken to a bidding page, which contains a place for entering the bid amount.

Once the seller clicks submit button (Step 508), all the details will be sent to the web server 1 and stored (Step 509) in the database server 2. There may be multiple sellers placing bids for a posting.

The auction ends (Step 510) at the time specified by the buyer at posting. The buyer may end the auction prior to the specified time and select a winning bidder if he wishes. Once the auction ends, a notification mail (Step 511) will be sent to the buyer as well as the sellers who have placed bids for that posting.

Once the auction ends, the buyer will review the bids (Step 512) obtained for his posting. He can select a winning bidder based on bid amount, bid description, sellers' profile and prior feedbacks. When the buyer selects a winning bidder (Step 513) database server 2 will be updated (Step 514). The web server 1 will send a notification mail (Step 515) to the winning seller and the seller should confirm the acceptance.

When the seller confirms the acceptance (Step 516) a fee will be taken (Step 517) he will be charged a fee according to his payment option as specified during account setup.—. This payment information will be stored in the database server2. The fee taken from the winning seller may be either a fixed amount or a percentage of the winning bid amount. The seller can view the payment details anytime through this site itself.

The seller and buyer will be advised to take a printout (Step 518) of the finished transaction. This can contain information related to the service or product and contact details of seller and buyer.

Once the seller and buyer complete the transaction of the specified service or product both of them can leave mutual feedback (Step 519). This will be stored (step 520) in the database server 2 for future reference.

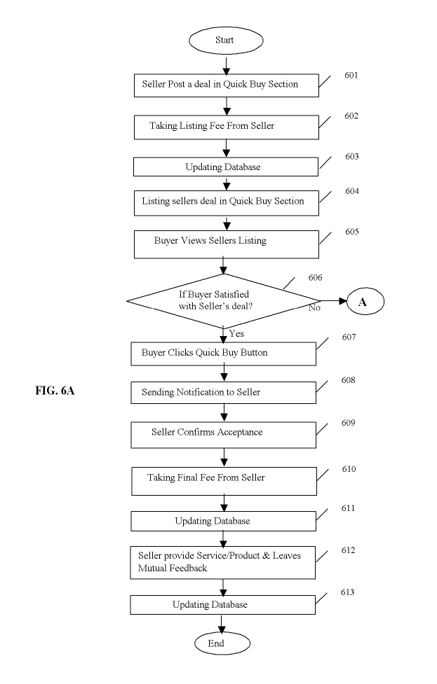

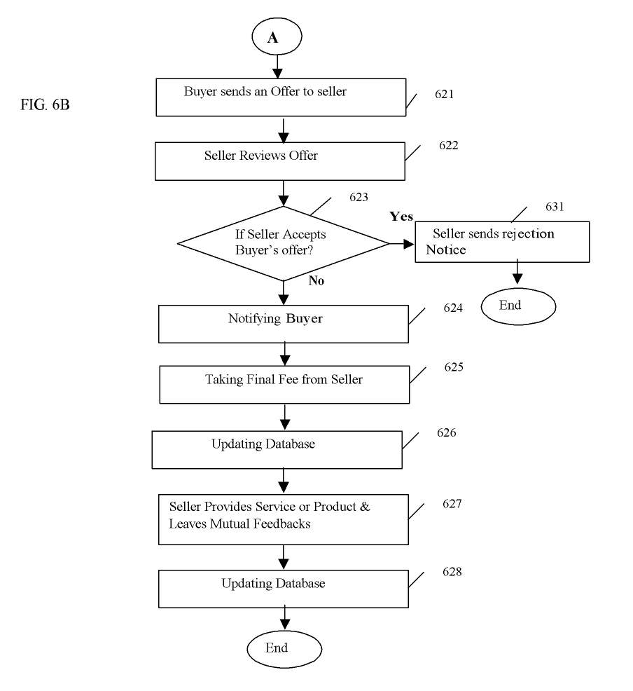

Referring to FIG. 6 is shown a block diagram explaining the feature called quick buy. Sometimes the buyer may need a service or package of services in a limited period of time. In such a situation buyer may not be having enough time to post the request, wait for the bids and finally select a winning seller at the end of auction. Quickbuy is a solution to the above scenario, in which buyers will be able to buy a particular service or package of services instantly from the desired category, which is posted by the sellers in the quickbuy section. There will be a fee taken from seller in order to list a quick buy service or package of service. Also there will be a fee taken from the seller when a buyer comes and buys that listed service or package of service. This fee may be a fixed amount or percentage of the amount, which the seller offered through the quick buy listing.

Referring to FIG. 6 Seller can post a Deal for a particular Service or Package of services in the Quick Buy section by clicking on Post (Step 601) in Quick Buy button or link. The seller will be taken to a web page containing a form to collect information from the seller. The information collected may include a title, category in which deal is to be posted, a detailed description and period of listing. When seller posts a deal in quick buy he will be charged a fee (Step 602) according to his payment option as specified during account setup—. All collected information regarding the posting as well as fee information will be stored (Step 603) database server2. Once the above step is done seller's deal will be listed (Step 604) in the specified category for a time period specified by the seller during posting.

A buyer who needs any service or package of service in a limited time will click the Quick Buy link. Buyers can browse through the categories and find deals posted by sellers in corresponding categories. Buyers can view (Step 605) the posting of a seller by clicking on the title of the posting. Buyers will then be taken to a web page displaying the details posted by the seller. Details shown may include a title, an amount and service or package of service description. In order to help in deciding whether to buy or not buy, buyer can review seller's pricing, service or package of service description, feedback and Profile. If the buyer is satisfied with the sellers deal (Step 606) he can click on the Quick Buy button (Step 607) displayed on that page. The web server 1 will then send a notification mail (Step 608) to the seller. Seller confirms (Step 609) the acceptance by clicking a link provided in that mail. A fee will be taken (Step 610) from sellers Credit/Debit card. The fee taken may be either a fixed amount or a percentage of the amount seller has offered. The payment information will then be stored (Step 611) in the database server 2. Seller and buyer can communicate with each other and seller should provide specified service or package of service (Step 612) to the buyer. Seller and buyer leave mutual feedback (Step 612) that will be stored (Step 613) in the database server 2 for future reference.

### Detailed Description of the Preferred Embodiment

The present invention comprises of a system and method that provides classified auction of products and services, which covers day-to-day needs of individuals and business under one platform. All categories related to these products and services will be shown to buyer during the step 403 in FIG. 4A.

One aspect of the present invention is that the buyer is not forced to specify an opening price while posting a service or product request details in step 404 of FIG. 4A. The present invention also provides a feature for seller, which allows entering a detailed bid description of the service or product along with the bid amount. This is incorporated in to the system in step 508 of FIG. 5A. This feature can avoid the conflicts between the seller and a buyer in later stage.

The present invention further provides the buyer a feature to select the winning seller (Step 413,FIG 4B) based on the bid amount, bid description, profile, feedback and ratings. This feature gives the buyer more flexibility to choose a right seller, who can satisfy the complete needs.

One aspect of the present invention is that it gives the buyers an option to decide whether he wishes to accept sealed bids. In a sealed bid, the bid amount will be visible only to the buyer and the seller who posted that sealed bid.

Referring now to FIG. 5A, if the buyer has selected to accept sealed bids (Step 506), the seller gets an option (Step 507) to provide a sealed or unsealed bid according to his wish. If the buyer selects not to accept sealed bid, then the seller won't be able to provide a sealed bid.

In the Step 606(FIG.6A), if the buyer is not satisfied with the deal listed by the seller, buyer will be given an option to send an offer to that seller. This is shown in FIG.6B. Clicking on the Send (Step 621) an offer button or link can do this. The offer may include a price and a description. This information will be collected and sent to seller through e-mail. Seller can review (Step 622) the offer sent by the buyer. If the seller (Step 623) is not ready to accept that offer, he can send a rejection notice (Step 631) to the buyer by clicking on a link in the e-mail.

In the Step 623, if the seller is ready to accept the offer sent by the buyer, he can confirm the acceptance by clicking on a link meant for that in the e-mail. A notification mail will be sent (Step 624) to the buyer, and a final fee will be taken (Step 625) using the seller's payment method & Payment information will be stored (Step 626) in the database server 2. Seller and buyer can communicate with each other and seller should provide the specified service or product (Step 627) to the buyer. Seller and buyer leave mutual feedback (Step 627) that will be stored (Step 628) in the database server 2 for future reference.

What is claimed is:

1. An auction method, system and Internet platform for all kinds of Residential and Business Related products and services where registered requesters/buyers post their classifieds/requests and registered providers/sellers provide bids/competitive rates comprising the step that a buyer is not forced to specify an opening bid price.

2. An auction method, system and Internet platform of claim 1 where registered buyers post their classifieds/requests and registered sellers provide bids/competitive rates comprising a feature allowing sellers to enter a detailed bid description which can define or describe of the service along with the bid amount.

3. An auction method, system and Internet platform of claim 1 where registered requesters/buyers post their classifieds/requests and registered providers/sellers provide bids/competitive rates comprising a feature allowing buyers to select the winning seller based on the bid amount, bid description, profile, feedback and ratings.

4. An auction method, system and Internet platform of claim 1 where registered requesters/buyers post their classifieds/requests and registered providers/sellers provide bids/competitive rates comprising a feature giving requester/buyer a control to accept sealed bids and seller can place sealed or unsealed bid.

5. An auction method, system and Internet platform of claim 1 also comprises a method for registered providers/sellers to post instant buy services or a package of services and registered requesters/buyers to accept that or negotiate with providers/sellers.
